(19) United States
(12) Patent Application Publication
(10) Pub. No.: US 2009/0310358 A1
(43) Pub. Date: Dec. 17, 2009

(54) Optical Module For LED Array

(76) Inventors: Yuan-Chang Liou, Nantou (TW); Ching-Miao Lu, Taipei (TW)

Correspondence Address: LIN & ASSOCIATES INTELLECTUAL PROPERTY, INC., P.O. BOX 2339, SARATOGA, CA, 95070-0339, US

(21) Appl. No.: 12/141,065

(22) Filed: Jun. 17, 2008

(51) Int. Cl. F21V 7/00

(52) U.S. Cl. 362/241; 362/342

(57) ABSTRACT

An optical module for LED luminarie is provided. The optical module can be used with LED arrays so that the luminarie with LED arrays can utilize the present invention to improve the luminance, brightness, luminance uniformity and coefficient of utilization to meet the user's demands. The optical module includes at least a radiation guiding unit and at least an anti-glare unit. The radiation guiding units are arranged abreast to adjust the radiation pattern to fit the coverage range. The anti-glare unit is formed on the both sides of the radiation guiding unit to prevent glare. The optical module of the present invention, when used in a luminarie, can form the expected distribution curve according to the objects to be lighted.

### FIELD OF THE INVENTION

The present invention generally relates to an optical module, and more specifically to an optical guiding module for an LED light source so as to improve the uniformity and adjust the radiation pattern according to the lighted target.

### BACKGROUND OF THE INVENTION

The basic criteria for lighting design include illuminance, brightness, uniformity (lowest illuminance/average illuminance), coefficient of utilization (the flux received in the effective luminance range/the lighting source flux), luminaire efficacy (luminarie flux/light source flux), and so on. There is a trade-off between the coefficient of utilization and uniformity. It is a big challenge to improve high coefficient of utilization while to maintain the uniformity. How to reach a good balance between the coefficient of utilization and the uniformity remains a big task to the lighting designer.

Recently, the LED lighting is becoming popular. As the LED lighting has the advantages of eco-friendliness, high efficiency, low maintenance cost and long lifespan, the LED lighting will replace the conventional lighting source eventually, such as mercury lamp, incandescent lamp, halogen lamp. Since the single LED's flux is not sufficient for the luminance needed, an LED array with plurality of LEDs is needed. This type of LED light source has the following drawbacks:
1. Different lighted targets may require different second-order optical designs according to the distance from the light source (such as different height of the road), the shape of the lighted area, or the lighted space (different road width or distance between lamps). The suitable lighting distribution cannot be achieved by simply changing the LED array arrangement
2. The LED light source usually uses the housing as the second-order optical reflector; hence, it is difficult to form optimal radiation pattern.
3. LED's light radiation is directional, thus, the LED light source can easily generate glare and cause uniformity problem which make the user uncomfortable.
4. The same LED chips may generate different radiation patterns because of the different packaging manner or packaged by different manufacturers. Therefore, the second-order optical design of the lighting device is restricted by the packaging manufacturer and the packaging method.

Therefore, the present invention provides an optical module which can guide the LED light radiation to the righted area with expected efficacy.

### SUMMARY OF THE INVENTION

The primary object of the present invention provides an optical module which can adjust the radiation pattern to match the lighted target requirement, in the mean time, to maintain high uniformity and efficiency.

Another object of the present invention provides an optical module with high efficacy by using highly reflective material on reflector surfaces to reduce the flux decay to enhance efficacy.

To achieve the aforementioned objects, the present invention provides an optical module, including, at least, a light radiation guiding unit, and, at least an anti-glare unit. The plurality of light radiation guiding units is arranged abreast which including a pair of opposite reflector, 1^{st} and 2^{nd} reflector,. The 1^{st} reflector forms an angle θ₁ from the center line of LED light source, the 2^{nd} reflector forms an angle θ₂ from the center line of LED light source. The angle of θ₁ and θ₂ are within 0°−89°.

The anti-glare unit includes a pair of light reflectors, crossed the light radiation guiding unit, allocated on the both sides of the light radiation guiding unit. The 1^{st} light reflector forms an angle φ₁ with the center line, and the 2^{nd} light reflector forms an angle φ₂ with the center line. Both φ₁ and φ₂ are within +89°to −89° with the center line. When the optical module of the present invention is applied to the LED array, the light beam from the LED array can be guided to the target area which leads to improve the coefficient of utilization.

For better understanding the foregoing object's features and advantages of the present invention, herein, provides the appropriate example accompany with drawings.

### BRIEF DESCRIPTION OF THE DRAWINGS

FIG. 1 shows a three-dimensional schematic view of the first embodiment according to the present invention;

FIG. 2 shows a cross-sectional view of the AA side shown in FIG. 1;

FIG. 3 shows a cross-sectional view the BB side shown in FIG. 1;

FIG. 4 shows cross-sectional schematic view of a lighting device utilizing the optical module of the present invention;

FIG. 5 shows a distribution curve of a street light without the optical module of the present invention;

FIG. 6 shows a distribution curve of a street light utilizing the optical module of the present invention;

FIG. 7 shows a distribution curve of a street light utilizing the optical module of the present invention;

FIG. 8A shows a three-dimensional view of the second embodiment of the present invention;

FIG. 8B shows a cross-sectional view of the second embodiment of the present invention; and

FIG. 9 shows a three-dimensional view of the third embodiment of the present invention.

### DETAILED DESCRIPTION OF THE PREFERRED EMBODIMENTS

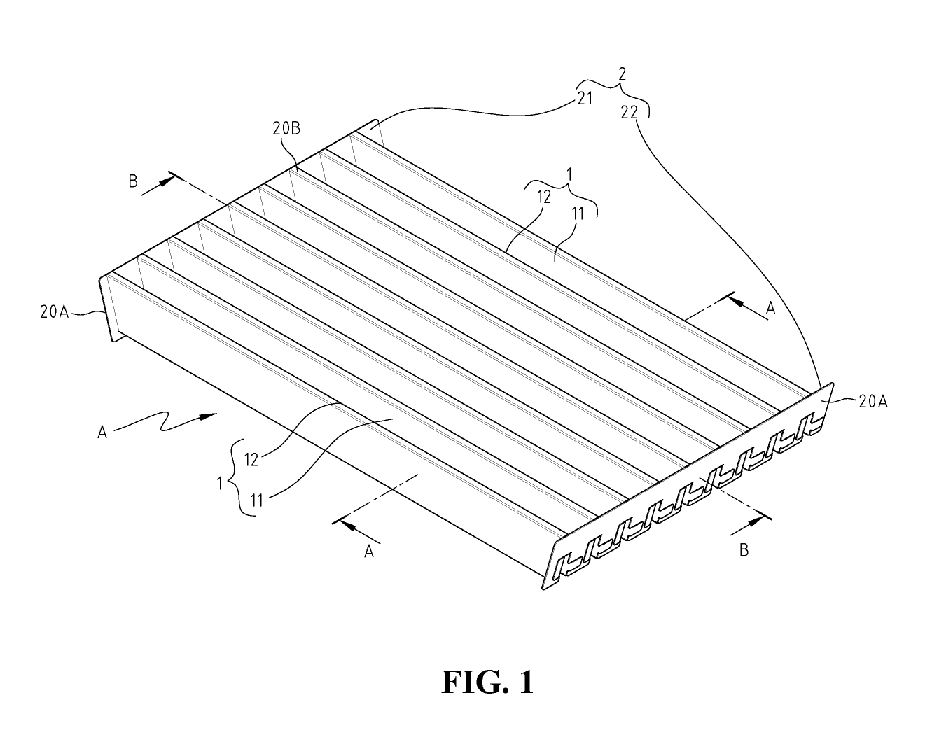

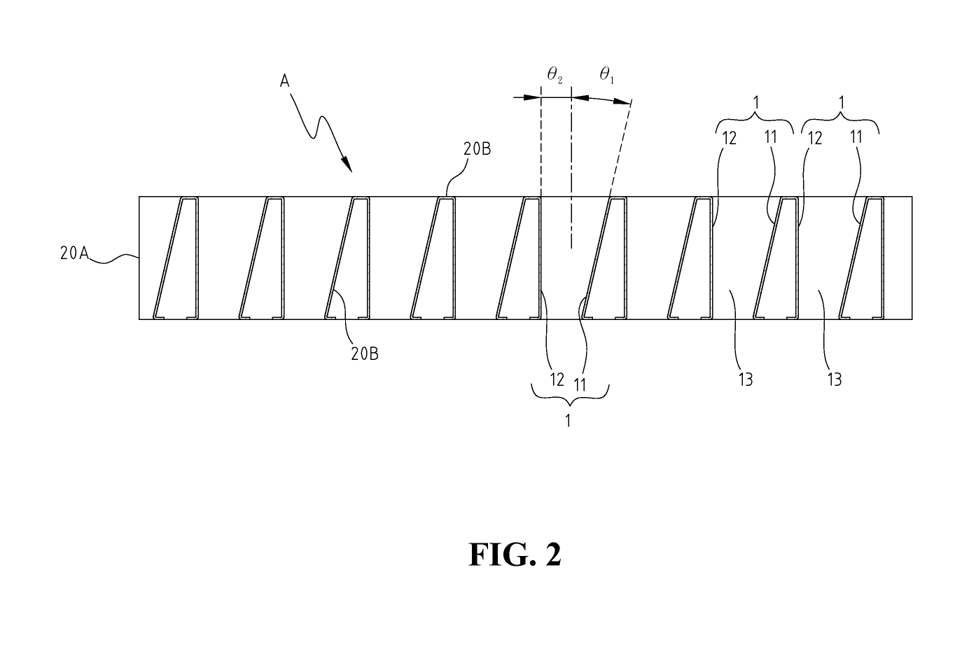

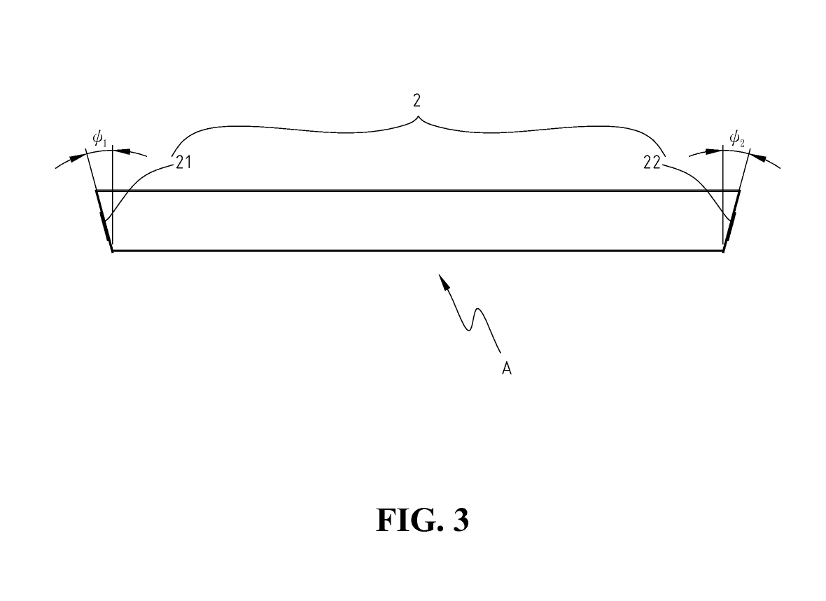

FIG. 1 shows a schematic view of an optical module for LED array. An optical module A is applied to an LED array so that the light beam from the LED array can be guided and reflected by optical module A to achieve the target illuminance, brightness, luminance uniformity, coefficient of utilization, and luminarie efficiency within the lighted area. Optical module A includes at least a radiation guiding unit 1 and at least an anti-glare unit 2. The plurality of radiation guiding units 1 is arranged abreast. Each radiation guiding unit 1 includes a first reflector 11 and a second reflector 12, as shown in FIG. 2. First reflector 11 and second reflector 12 face each other. First reflector 11 forms an angle θ₁ with the center line, and second reflector 12 forms an angle θ₂ with the center line. Both θ₁ and θ₂ are within 0°−89°. In the present embodiment, θ₂ is 0°. A space 13 exists between first reflector 11 and second reflector 12, serving as an area for light penetration and reflection. The light source is located at the bottom of space 13. The light source can be LED. As shown in FIG. 1 and FIG. 3, each anti-glare prevention unit 2 includes a first reflector 21 and a second reflector 22. First reflector 21 and second reflector 22 are located on the both sides of radiation pattern unit 1, respectively. First reflector 21 forms an angle φ₁ with the center line, and second reflector 22 forms an angle φ₂ with the center line. Both φ₁ and φ₂ are within 0°−89°. In the present embodiment, φ₁=φ₂.

The structural components of optical module A of the present invention are not limited to any specific shape. Different shapes of radiation guiding units and anti-glare units can be designed for different shapes of LED light sources. FIG. 1 shows the first embodiment, in which first reflector 21 and second reflector 22 of anti-glare unit 2 are a large-area first light guiding plate 20A, respectively. There is a plurality of second light guiding plates 20B, with each second light guiding plate 20B having a first reflector 11 and a second reflector 12. The two sides of the plurality of arranged second light guiding plates 20B are engaged to first light guiding plate 20A, respectively, to form optical module A of the present invention.

The main function of radiation guiding unit 1 is to reflect the light shedding on the ineffective area, e.g., the lateral direction of the road, to the effective area, e.g., along the traffic direction of the road, through first reflector 11 and second reflector 12. In other words, the concentric radiation pattern is adjusted to become a flat long stripe radiation pattern to match the lighted area shape. First reflector 11 and second reflector 12 can be either symmetric or asymmetric. The present embodiment uses asymmetric style, i.e., θ₁ is not equal to θ₂. The vertical heights and angles θ₁, θ₂ of first reflector 11 and second reflector 12 are determined by the traffic direction (tangent), road width (lateral), and the optical axis of the light source using a specific equation, combined with the location, the tilting angle, and the overhand of the lighting device, in order to generate a radiation pattern close to the two edges of the lighted area.

The main function of anti-glare unit 2 is to reflect the light shedding on the ineffective area, e.g., the lateral direction of the road, to the effective area, e.g., along the traffic direction of the road, through first light guiding reflector 21 and second light guiding reflector 22 to improve the coefficient of utilization and to prevent the glare in the road traffic direction which may interfere with the drivers.

To improve the luminarie efficiency, in the present embodiment, first reflector 11, second reflector 12, first light guiding reflector 21 and second light guiding reflector 22 have reflectivity higher than 85%. Therefore, first reflector 11, second reflector 12, first light guiding reflector surface 21 and second light guiding reflector surface 22 are all made of materials with high reflectivity, such as metal electroplated with silver or aluminum, whose reflectivity can reach as high as 95%, and the flux decay of each reflection is small.

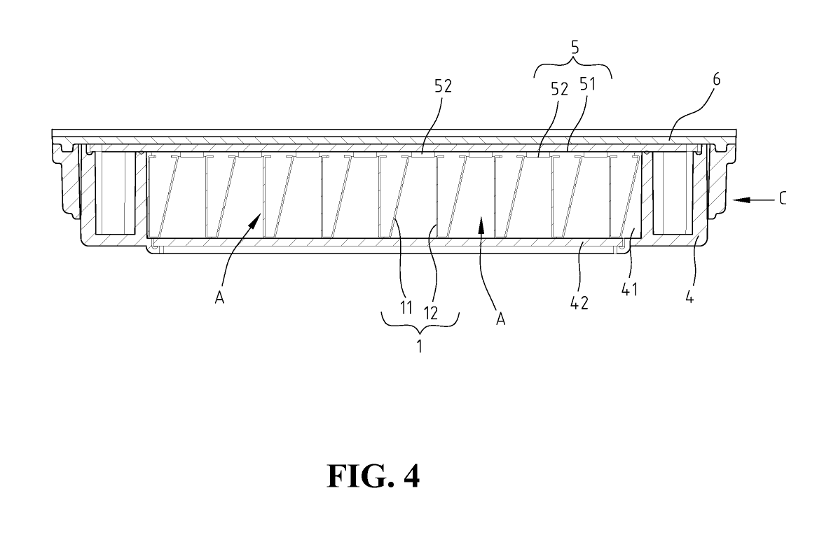

FIG. 4 provides a schematic cross-sectional view of an actual application of the present invention in a luminaries A light source C includes a light shade 4, an LED array 5, a heat-dissipation base 6, and optical module A of the present invention. The interior inside light shell 4 is a housing space 41 for housing LED array 5 and optical module A. LED array 5 includes a circuit board 51 and a plurality of LEDs 52 arranged in a plurality of rows on circuit board 51. Each row of LEDs 52 corresponds to a radiation guiding unit 1 of optical module A, and is located in the space between first reflector 11 and second reflector 12. Heat dissipation base 6 is attached to the back of LED array 5, and is engaged to light shell 4. Light shell 4 includes a lens 42, located on the light penetration path in front of optical module A. Because light source C uses optical module A of the present invention, the radiation pattern, illuminance, brightness, luminance uniformity and coefficient of utilization are better than the conventional device.

The following example is provided for further explanation of the present invention. Take the street light as an example. The conventional lighted area for street light is not square. The ideal lighted area should be rectangular. The actual lighted area is adjusted according to the factors, such as, road width, pole distance, light height, and so on. In the present example, the conditions are as follows:
1. Road width is 6 m, light height 6 m, pole distance 18 m, installed single-sided.
2. The tilting angle of luminarie is 15°, overhand 0.78 m, traffic direction defined as X-axis, road width as Y-axis, pole located at the origin, i.e., (X=0, Y=0). Therefore, each luminarie is responsible for the area −9 m<=X<=9 m and 0 m<=Y<=6 m, which is the regulated lighted area.
3. The height of the radiation guiding unit of the optical module is 20 mm, with a flat shape. Angles θ₁, θ₂ of first reflector 11 and second reflector 12 of the radiation guiding unit are 12° and 7°, respectively. Angles φ₁, φ₂ of the anti-glare unit on both sides are both 0°. The optical module is made of highly reflective material, such as aluminum-plated or silver-plated metal, with reflectivity as high as 95%.
4. the radiation pattern of LED light source is Lambertian with a total of 1136 Lm.

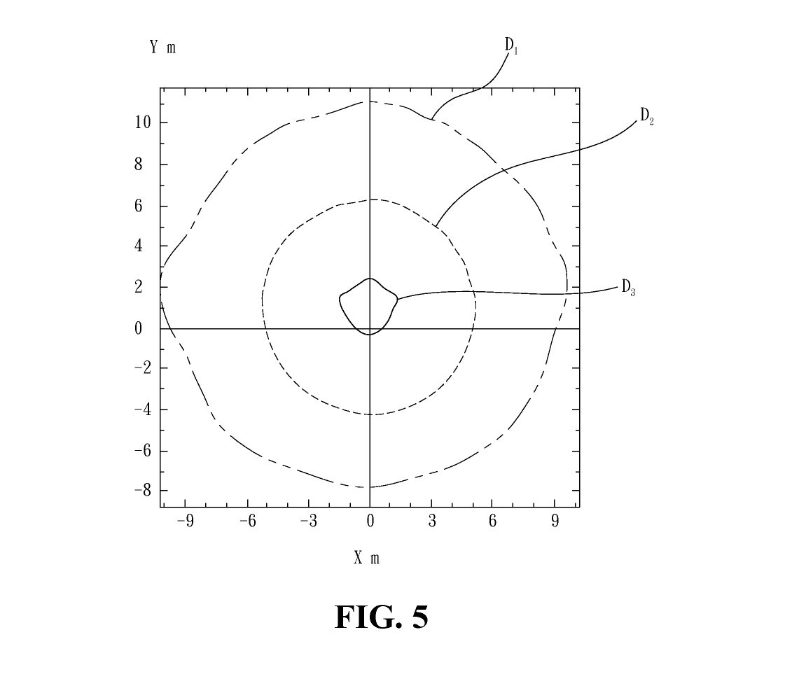

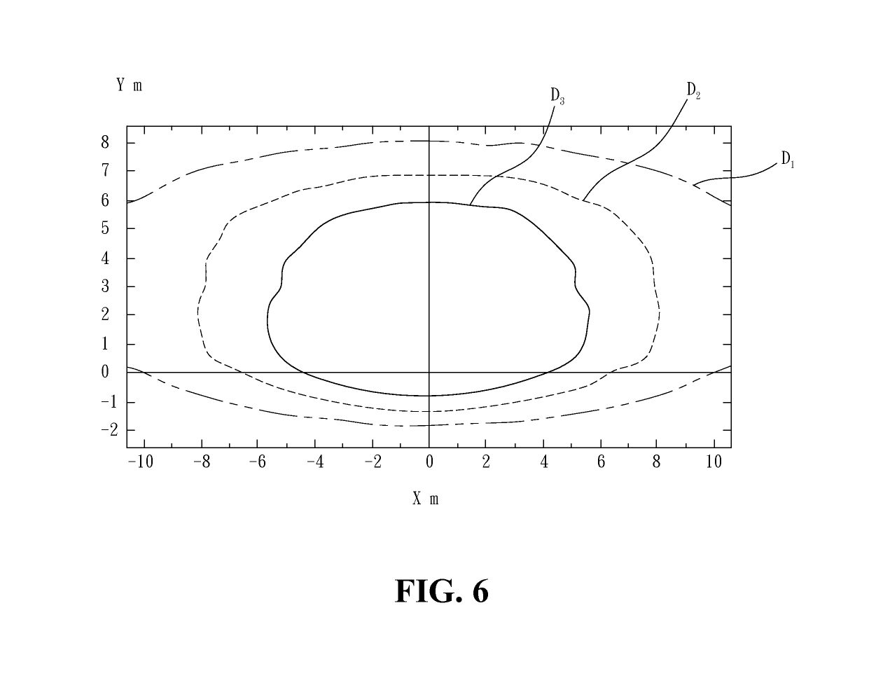

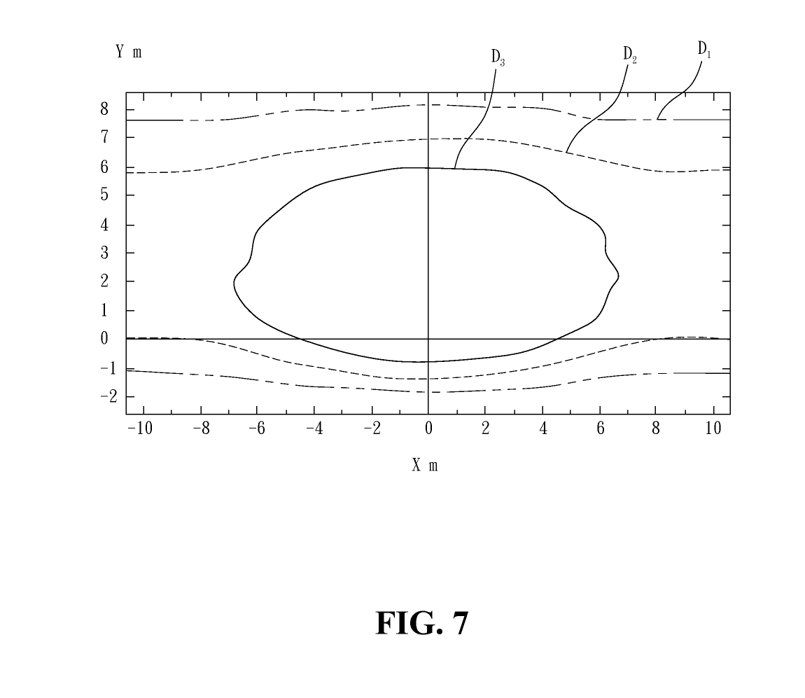

FIG. 5 sows the illuminance distribution on the road surface by the street light without using the optical module of the present invention. The illuminance distribution is for a single street light. The maximum illuminance is 6.4 Lux. D1 is the distribution of equi-illuminance curve for 1 Lux, D2 is the distribution of equi-illuminance curve for 2 Lux, and D3 is the distribution of equi-illuminance curve for 6 Lux, the same for D1, D2 and D3 in FIGS. 6-7. The conventional street light without the optical module of the present invention has LED light source with axis-symmetric radiation pattern; therefore, the radiation pattern on the road surface is concentric. That is, a large amount of light beam sheds outside of the road (i.e., −6 m<=Y<=0 m), which is entirely wasted.

FIG. 6 shows the illuminance distribution on the road surface by the street light using the optical module of the present invention. The illuminance distribution is for a single street light. The maximum illuminance is 16.2 Lux. Because the optical module can effectively prevent light beam reflected outside the road. The range covered by the equi-illuminance for 6 Lux is greatly changed. The increase could be three times almost, i.e., from 6.4 Lux to 16.2 Lux. The distribution of the illuminance becomes an oval shape, which means the radiation pattern is closer to the lighted area shape, and the light source utilization is improved.

FIG. 7 shows the illuminance distribution on the road surface by using the optical module of the present invention. The illuminance distribution is resulted from three street lights. The left lamp is located at X=−18 m and Y=0 m. The right lamp is located at X=18 m and Y=0 m. The maximum illuminance is 16.6 Lux. As shown in FIG. 7, the radiation pattern is a long stripe that stays close to the edges of the road. The average illuminance is 8.3 Lux, which is more than twice of the 3.8 Lux for the lamps without the optical module of the present invention. The uniformity is 0.34, that just matches the code requirements, and the coefficient of utilization is 79%, much higher than the conventional 40-50%.

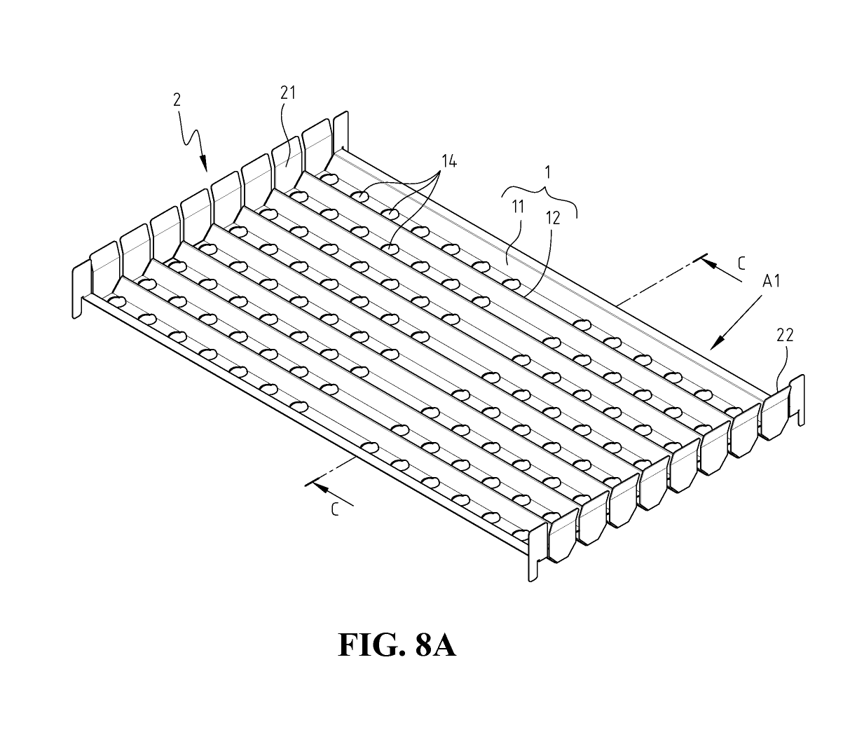

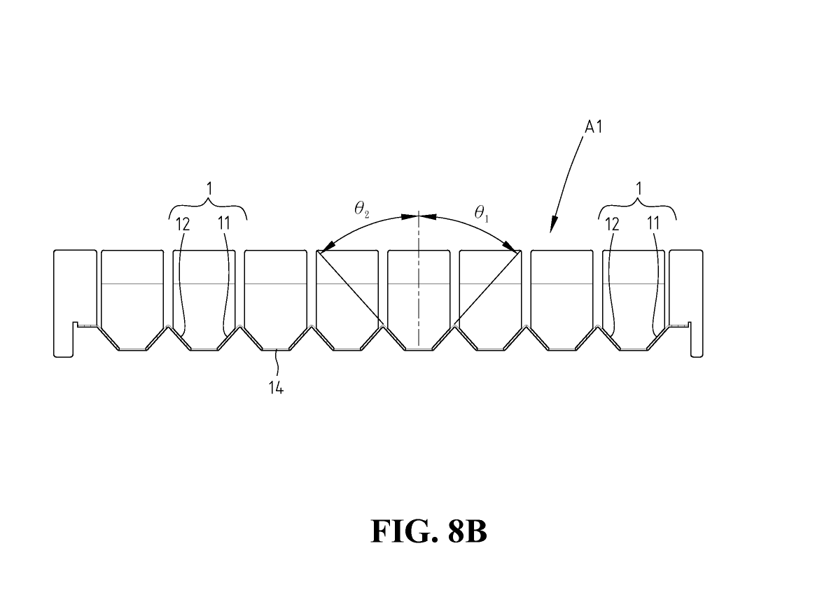

The optical module of the present invention is not limited to certain shape or type. The following two embodiments show two different structures. FIGS. 8A and 8B show a three-dimensional and cross-section view of the second embodiment of the present invention, respectively. In the second embodiment, optical module A1 includes at least a radiation guiding unit 1 and at least a anti-glare unit 2. However, in this embodiment, first reflector 11 and second reflector 12 of radiation guiding unit 1 are symmetrically placed, i.e., θ₁=θ₂. In addition, there is a plurality of hole trenches 14 between first reflector 11 and second reflector 12 for placing LEDs. In this embodiment, the shape of hole trench 14 is circular, matching the shape of a single LED. Each radiation guiding unit 1 corresponds to a anti-glare unit 2. First reflector 21 and second reflector 22 are located on the both sides of the radiation guiding unit 1, respectively. Also, first reflector 21 forms two different tilting angles, and second reflector 22 also forms two different titling angles.

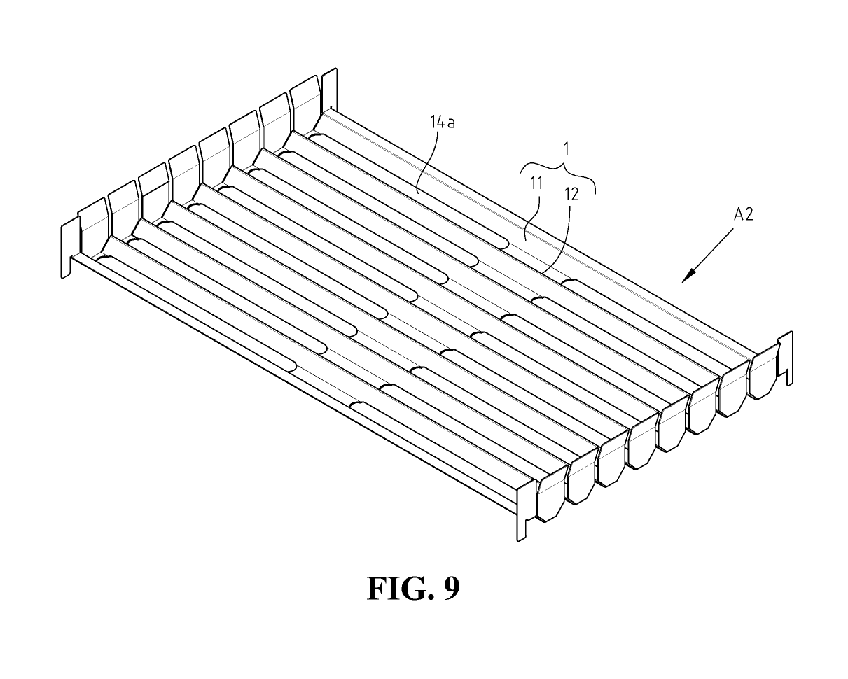

FIG. 9 shows the third embodiment of the present invention. The third embodiment is similar to the second embodiment of FIG. 8A, except that hole trench 14A between first reflector 11 and second reflector 12 of optical module A2 of FIG. 9 is a long strip for placing a plurality of LEDs. Therefore, it is clear that the optical module of the present invention is not limited to any specific shape or type, and can be designed to match different needs.

In summary, the optical module of the present invention provides the following advantages:
1. The radiation pattern can be adjusted by lighted target's requirements, so as to achieve better coefficient of utilization
2. Prevent glare.
3. The present invention has a simple structure that can be easily redesigned to meet the application's need, such as road width, pole distance, luminarie height, and so on.
4. The reflector surfaces of the present invention are made of high reflective material so as to improve the coefficient of utilization and luminarie efficiency.

The reference description is one of the example only, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed:

1. An optical module for LED light module, applicable to being used with an LED array, said optical module comprising:
at least a radiation guiding unit, each said radiation guiding unit further comprising a first reflector and a second reflector, said the two reflectors facing each other, said first reflector forming an angle θ₁ with the center line between said first reflector and said second reflector, and second reflector forming an angle θ₂ with said center line, both θ₁ and θ₂ within 0°−89°; and
at least an anti-glare unit, each said anti-glare unit further comprising a pair of light reflectors, said first reflector and said second reflector located on the both sides of said radiation guiding unit, said first reflector 21 forming an angle φ₁ with said center line, and second reflector forming an angle φ₂ with said center line, both φ₁ and φ₂ within +89° to '89°.

2. The optical module as claimed in claim 1, wherein said LED array further comprises a circuit board and a plurality of LEDs, said LEDs are arranged as a plurality of rows on said circuit board, each said row of LEDs corresponds to a said radiation guiding unit, and said row of LEDs is located between said first reflector and said second reflector.

3. The optical module as claimed in claim 1, wherein said radiation guiding units are arranged abreast and are integrated with said anti-glare units.

4. The optical module as claimed in claim 1, wherein the design of said radiation guiding unit is asymmetric, i.e., θ₁ is unequal to θ₂.

5. The optical module as claimed in claim 1, wherein the design of said radiation guiding unit is symmetric, i.e., θ₁ is equal to θ₂.

6. The optical module as claimed in claim 1, wherein the reflectivity of said first reflector and said second reflector is higher than 85%.

7. The optical module as claimed in claim 6, wherein said first reflector and said second reflector are electroplated with a layer of silver.

8. The optical module as claimed in claim 6, wherein said first reflector and said second reflector are electroplated with a layer of aluminum.

9. The optical module as claimed in claim 1, wherein the height of said first reflector and said second reflector is determined by the object to be lighted.

10. The optical module as claimed in claim 1, wherein 01 and 02 are determined by the coverage range of the objects to be lighted.

11. The optical module as claimed in claim 1, wherein the reflectivity of said first light reflector and said second light reflector said anti-glare unit is higher than 85%.

12. The optical module as claimed in claim 1, wherein a space exists between said first reflector and said second reflector of said radiation guiding unit.

13. The optical module as claimed in claim 1, wherein a plurality of hole trenches are located between said first reflector and said second reflector of said radiation guiding unit.

14. The optical module as claimed in claim 13, wherein said hole trench is a long trench.

15. The optical module as claimed in claim 13, wherein said hole trench is a round hole.
